(19) United States
(12) Patent Application Publication
(10) Pub. No.: US 2007/0181095 A1
(43) Pub. Date: Aug. 9, 2007

(54) Fuel injection controller

(75) Inventor: Koji Hata, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/656,941

(22) Filed: Jan. 24, 2007

(30) Foreign Application Priority Data
Feb. 7, 2006 (JP) 2006-29100

(51) Int. Cl. F02B 3/00; G06F 17/00

(52) U.S. Cl. 123/299; 701/104

(57) ABSTRACT

A fuel injection controller of an internal combustion engine calculates a correction value for correcting a rotation fluctuation amount among cylinders of the engine during idling stabilization control. The controller calculates an average change in correction value over M number of changes in correction value for the cylinder. If it is determined that the average change is less than or equal to a threshold value a, it is determined that the correction value is stabilized. The correction value at that time is fixed as a learning value of a deviation amount of an injection characteristic among the cylinders. Thus, the fuel injection controller suitably achieves accurate learning of an inter-cylinder variation in the injection characteristic of the fuel injection valve and performing of the learning in a short time.

### CROSS REFERENCE TO RELATED APPLICATION

This application is based on and incorporates herein by reference Japanese Patent Application No. 2006-29100 filed on Feb. 7, 2006.

### BACKGROUND OF THE INVENTION

1. Field of the Invention

The present invention relates to a fuel injection controller that learns a deviation amount of an injection characteristic of a fuel injection valve of a multi-cylinder internal combustion engine.

2. Description of Related Art

There is a known diesel engine that performs a pilot injection before a main injection in order to reduce a noise accompanying combustion or to improve exhaust gas characteristics, the pilot injection injecting a smaller injection amount than the main injection.

Even if a command value of an injection period or a command value of an injection amount (command injection amount) of a fuel injection valve is equalized to control the fuel injection, there is a possibility that the actually injected fuel amount varies due to an individual difference of the fuel injection valve. Specifically, the pilot injection injects extremely small amount of the fuel compared to the main injection. Therefore, if the actual injection amount deviates from a desired injection amount, sufficient achievement of the above-described objects becomes difficult.

Therefore, a proposed feedback control system performs a calculation in which a predetermined injection amount Q is divided by a predetermined variable N. That amount of fuel Q/N is injected N times, and actual rotational speed of the engine is monitored. Each injection amount Q/N is controlled to conform the actual rotational speed to target rotational speed by feeding back the result of the monitoring to the fuel injection amount Q/N. If the actual rotational speed approximately equals the target rotational speed, then a learning value is acquired by the system. In other words, the learning value is used for compensating for the difference between the command injection amount and the desired injection amount. This type of control system is disclosed, for example, in JP-A-2003-254139. Moreover, the control system performs the feedback control to compensate for a rotation fluctuation among cylinders. Since the control system performs N-divided fuel injections, the control system can learn the fuel injection characteristic as of performing the minute amount fuel injection (e.g., pilot injection). As a result, the control system can obtain an appropriate learning value.

The time necessary for obtaining the learning value should be preferably as short as possible. However, when the processing for obtaining the learning value is performed for the first time, e.g., when the fuel injection controller is shipped as a product, the time necessary for the actual rotational speed to converge to the target rotational speed through the feedback control tends to be long. Accordingly, the obtainment of the learning value takes a long time if the learning is performed such that the convergence time elapses sufficiently when the processing for obtaining the learning value is performed for the first time. The inventors also discovered that accurate calculation of the fluctuation correction value for compensating for the rotation fluctuation among the cylinders becomes difficult if the time for obtaining the learning value is shortened.

In addition to the learning of the pilot injection, difficulty in simultaneous pursuit of the accurate learning of the variation in the injection characteristic among the cylinders and the learning in a short period is common to any fuel injection controller compensating for the variation in the injection characteristic among the cylinders.

### SUMMARY OF THE INVENTION

It is an object of the present invention to provide a fuel injection controller capable of suitably and simultaneously achieving learning of a variation among injection characteristics of fuel injection valves of respective cylinders and performing the learning in a short period.

According to an aspect of the present invention, a learning means of a fuel injection controller has a determining means for determining whether a fluctuation correction value is stabilized based on an average change in the fluctuation correction value. The learning means learns a deviation amount if the determining means determines that the fluctuation correction value is stabilized.

With this structure, it is determined whether the fluctuation correction value is stabilized based on the average change in the fluctuation correction value. Accordingly, the learning of the deviation amount based on the fluctuation correction value can be averted when the fluctuation correction value can fluctuate. The deviation amount is learned immediately when the fluctuation correction value is stabilized. Thus, the learning period is not lengthened unnecessarily.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a schematic diagram showing an engine system according to an example embodiment of the present invention;

FIG. 2 is a map for setting an injection period from an injection amount and fuel pressure according to the FIG. 1 embodiment;

FIG. 3 is a diagram showing a relationship between the number of convergence and a convergence time of a correction value according to the FIG. 1 embodiment;

FIG. 4 is a diagram showing a converging mode of the correction value according to the FIG. 1 embodiment; and

FIG. 5 is a flowchart showing steps of learning processing of a learning value according to the FIG. 1 embodiment.

### DETAILED DESCRIPTION OF EXAMPLE EMBODIMENT

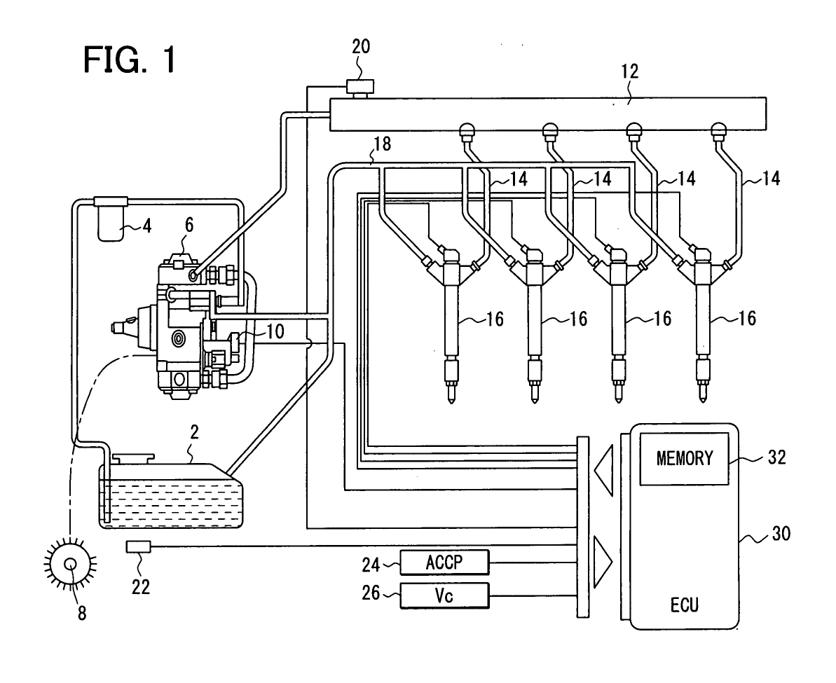

Referring to FIG. 1, an engine system according to an example embodiment of the present invention is illustrated. As shown in FIG. 1, a fuel pump 6 draws fuel from a fuel tank 2 through a fuel filter 4. The fuel pump 6 is applied with a power from a crankshaft 8 as an output shaft of the diesel engine and discharges the fuel. The fuel pump 6 has a suction metering valve 10. The suction metering valve 10 regulates a fuel amount discharged from the fuel pump 6 by regulating a suctioned fuel amount. The fuel amount discharged to an outside is decided by operating the suction metering valve 10. The fuel pump 6 has multiple plungers. Each plunger reciprocates between a top dead center and a bottom dead center to suction and discharge the fuel.

The fuel discharged from the fuel pump 6 is pressure-fed to a common rail 12. The common rail 12 accumulates the fuel, which is pressure-fed from the fuel pump 6, at a high-pressure state. The common rail 12 supplies the high-pressure fuel to fuel injection valves 16 of respective cylinders (four cylinders in the present embodiment) through high-pressure fuel passages 14. The fuel injection valves 16 are connected with the fuel tank 2 through a low-pressure fuel passage 18.

The engine system has various types of sensors for sensing operation states of the diesel engine such as a fuel pressure sensor 20 for sensing the fuel pressure in the common rail 12 and a crank angle sensor 22 for sensing a rotation angle of the crankshaft 8. The engine system has an accelerator sensor 24 for sensing an operation amount ACCP of an accelerator pedal operated in accordance with acceleration requirement of a user. The engine system further has a vehicle speed sensor 26 for sensing running speed Vc of the vehicle, in which the engine system is mounted.

An electronic control unit 30 (ECU) is structured mainly by a microcomputer. The ECU 30 has a constantly-memory-holding memory 32. The constantly-memory-holding memory 32 is a storage device for storing data regardless of a state of a start switch (ignition switch) of the engine. For example, the constantly-memory-holding memory 32 is a nonvolatile memory such as EEPROM, which holds data regardless of existence or nonexistence of power supply, or a backup memory, whose energization state is maintained regardless of the state of the start switch. The ECU 30 reads sensing results of the above-described sensors and controls the output of the engine based on the sensing results.

The ECU 30 performs fuel injection control to appropriately perform the output control of the diesel engine. For example, the fuel injection control is multi-step injection control for selectively performing certain injections out of pilot injection, pre-injection, main injection, after injection and post-injection during one combustion cycle. The pilot injection injects a minute amount of the fuel to promote mixing of the fuel and the air immediately before ignition. The pre-injection shortens a delay of ignition timing after the main injection. Thus, generation of nitrogen oxides is inhibited and a combustion sound and vibration are reduced. The main injection injects the largest injection amount in the multi-step injection and contributes to generation of the output torque of the engine. The after injection combusts exhaust particulate matters (PM) again. The post-injection controls temperature of the exhaust gas to regenerate an after treatment device of the engine such as a diesel particulate filter (DPF).

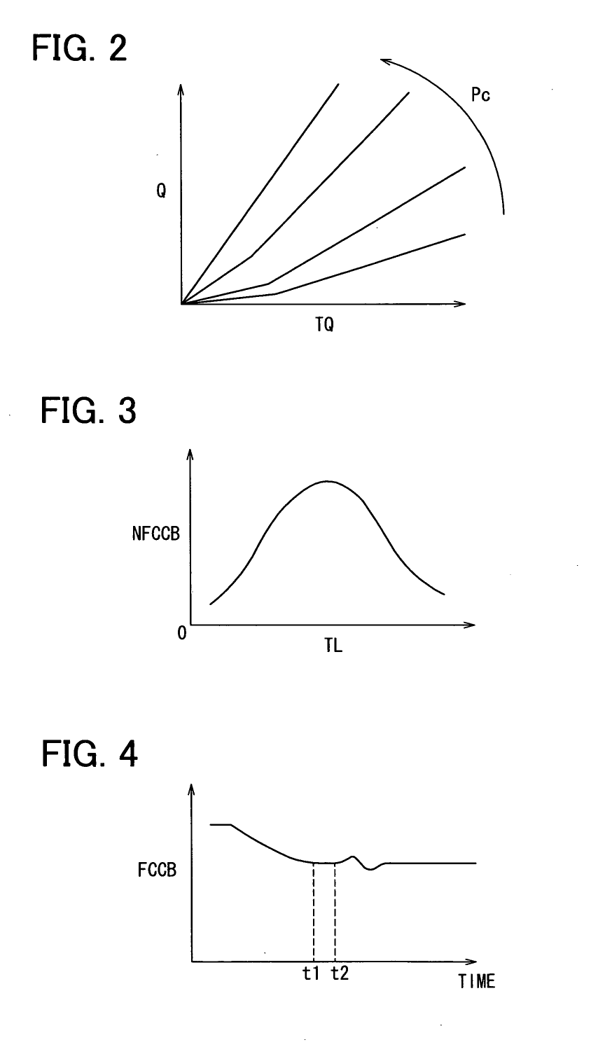

In the fuel injection control, the fuel pressure in the common rail 12 is controlled to a target value (target fuel pressure), which is set in accordance with an operation state of the engine, through feedback control. In order to perform the fuel injection of the command value of the injection amount (command injection amount) outputted to the fuel injection valve 16, a command value of the injection period (command injection period) of the fuel injection valve 16 is calculated based on the fuel pressure sensed by the fuel pressure sensor 20 and the command injection amount. For example, the command injection period is set by using a map shown in FIG. 2, which determines the relationship among the injection amount Q, the fuel pressure Pc and the injection period TQ. In FIG. 2, the injection period TQ is set longer as the injection amount Q increases if the fuel pressure Pc is the same. The injection period TQ is set shorter as the fuel pressure Pc increases if the injection amount Q is the same.

The actual fuel injection valve 16 has a variation in an injection characteristic because of an individual difference, a change with time (aging) and the like. Therefore, the injection amount actually injected from each fuel injection valve 16 does not necessarily coincide with the desired injection amount even if the fuel pressure and the injection period are fixed. Specifically, as for the minute amount injection such as the pilot injection out of the multi-step injection used in the fuel injection control of the diesel engine, the difference between the actual injection amount and the desired injection amount can become a problem for the fuel injection control.

Therefore, a deviation amount from the desired injection characteristic as of performing the minute amount injection (e.g., pilot injection) should be preferably learned. It is difficult to perform the learning by sensing the injection characteristic of the main injection specifically when the injection characteristic of the fuel injection valve 16 has a nonlinear relationship between the injection period TQ and the injection amount Q as shown in FIG. 2. The rotation state of the diesel engine as of the multi-step injection including the main-injection is significantly affected by the main injection. Therefore, it is difficult to learn the deviation amount of the injection characteristic of the minute amount injection based on the rotation state as of such multi-step injection.

Therefore, in the present embodiment, the fuel injection control is performed by dividing the required injection amount into equal injection amounts to learn the deviation amount related to the pilot injection. Each divided fuel amount is set at the minute fuel amount corresponding to the pilot injection. Thus, the injection characteristic of the fuel injection valve 16 related to the minute fuel amount can be sensed as the rotation state of the crankshaft 8. A correction value ISC for conforming an average value of the rotational speed of the crankshaft 8 during idling operation of the engine to target rotational speed is calculated, and a correction value FCCB for compensating for an inter-cylinder variation (variation among cylinders) in an increase of the rotational speed of the crankshaft 8 accompanying the fuel injections is calculated. The deviation amount of the injection characteristic of the fuel injection valve 16 of each cylinder is learned in accordance with the correction values ISC, FCCB. In order to learn the deviation amount with high accuracy, the correction values ISC, FCCB having converged to values for compensating for the variation in the injection characteristic of the fuel injection valve 16 should be preferably used.

FIG. 3 shows a convergence property of the correction value FCCB of the fuel injection valve 16. In FIG. 3, the axis of abscissas represents a learning period TL and the axis of ordinate represents the convergence number NFCCB of the correction value FCCB. As shown in FIG. 3, the correction value FCCB converges even if the learning period TL is relatively short in a certain fuel injection valve 16 but the convergence of the correction value FCCB takes a long time in another fuel injection valve 16. Therefore, in the case where the learning value is calculated based on the correction value FCCB at the time when a specific period elapses after the rotational speed of the crankshaft 8 converges to the target rotational speed, the specific time is set in accordance with the fuel injection valve 16 that needs a long time for the convergence. As a result, there is a possibility that the learning period becomes long unnecessarily. Specifically, in the case where the learning is performed after mass production of the fuel injection valves 16 and before the shipping of the fuel injection valves 16 as products, the time scale of the axis of abscissas of FIG. 3 becomes larger than in the case of the learning performed again after the learning. Therefore, the learning period TL tends to lengthen unnecessarily if the specific time is set at a sufficiently long time when the learning is performed for the first time after the mass production.

The learning period TL can be shortened by learning the learning value when a change in the correction value FCCB becomes less than or equal to a predetermined threshold value. However, in this case, as shown in FIG. 4, there is a possibility that the change in the correction value FCCB becomes less than or equal to the threshold value in a period between timing t1 and timing t2 and the learning is performed. The learning accuracy is deteriorated if the correction value FCCB fluctuates after the learning as shown in FIG. 4.

Therefore, in the present embodiment, it is determined whether the correction value FCCB is stabilized based on an average value of the change (i.e., average change) in the correction value FCCB. The deviation amount is learned under a condition that it is determined that the correction value FCCB is stabilized.

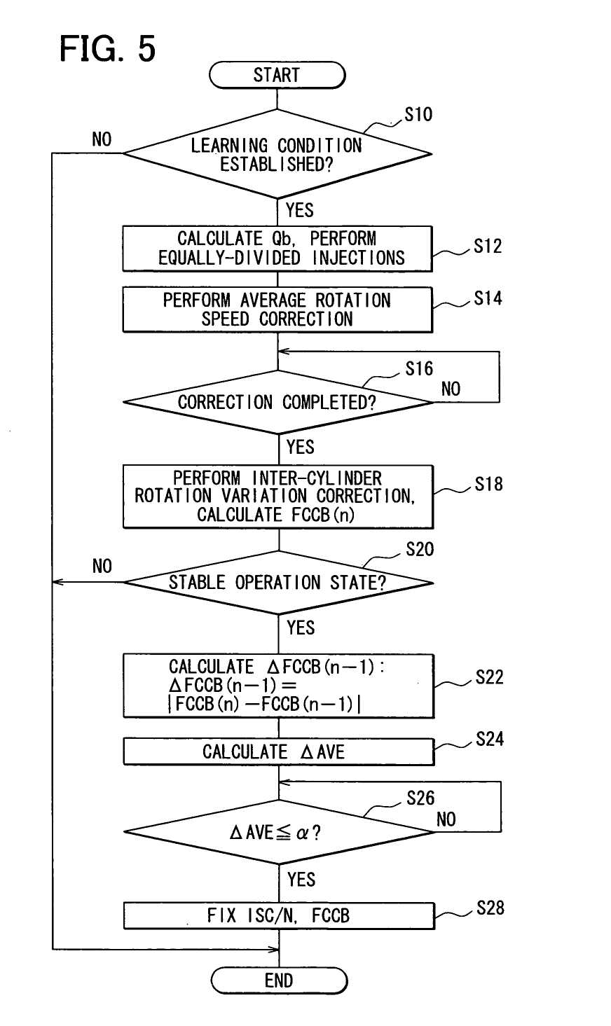

FIG. 5 shows learning processing steps according to the present embodiment. The ECU 30 performs the processing in a predetermined cycle, for example. In a series of the processing, first, Step S10 determines whether a learning condition is established. The learning condition includes a condition that idling stabilization control is performed, a condition that a pressed amount of the accelerator pedal sensed by the accelerator sensor 24 is zero, a condition that the running speed Vc of the vehicle sensed by the vehicle speed sensor 26 is zero, for example. The learning condition may include a condition that an in-vehicle head lamp is off or a condition that an in-vehicle air-conditioner is off.

If Step S10 is YES, the process goes to Step S12. Step S12 calculates a basic injection amount Qb. The basic injection amount Qb is an injection amount expected to be necessary for controlling the actual rotational speed of the crankshaft 8 to the target rotational speed during the idling. If the basic injection amount Qb is calculated, the basic injection amount Qb is divided by N, and fuel injection of the amount Qb/N is performed N times. The integer number N is set to conform the amount Qb/N to the pilot injection amount.

Then, Step S14 performs feedback control, in which the correction value ISC for matching the average value of the actual rotational speed to the target rotational speed is calculated and is added to the basic injection amount Qb to achieve the matching. More specifically, the summation of the correction value ISC and the basic injection amount Qb is divided by N to calculate the command injection amount. The fuel injection of the command injection amount is performed N times near a compression top dead center. The correction value ISC is for controlling the output torque of the crankshaft 8 generated by the collaboration of the fuel injections of the fuel injection valves 16 of the all cylinders to desired torque.

Then, Step S16 determines whether the correction of the average rotational speed is completed. Step S16 determines that the correction of the average rotational speed is completed when the change in the correction value ISC becomes less than or equal to a predetermined value.

Then, Step S18 performs correction of rotation fluctuation among the cylinders. In the present embodiment, Step S18 calculates the correction values FCCB of the command injection periods of the respective cylinders for equalizing the rotational speed increase amounts of the crankshaft 8 accompanying the injections of the divided fuel amounts in the respective cylinders. The summation of the basic injection amount Qb and the correction value ISC is divided by N to calculate the command injection amount, and the command injection amount is converted into the injection period. The injection period is corrected with each correction value FCCB to perform the fuel injection.

Then, Step S20 determines whether the operation state of the diesel engine is stabilized. Here, for example, it is determined whether the fluctuation amount of the rotational speed of the crankshaft 8 from the start of Step S18 to the present time is equal to or less than a predetermined fluctuation amount. The condition of the stabilized operation state may include a condition that the fluctuation amount of the load applied to the crankshaft 8 is equal to or less than a predetermined amount. The fluctuation amount of the load applied to the crankshaft 8 exceeds the predetermined amount when the head lamp is turned on or the in-vehicle air-conditioner is activated, for example.

Then, Step S22 calculates the change ΔFCCB in the correction value FCCB. Here, an absolute value of a difference between the previous correction value FCCB(n−1) and the present correction value FCCB(n) is calculated as the present change ΔFCCB(n−1).

Then, Step S24 calculates an average value ΔAVE of M number of changes ΔFCCB (M≧2) in the correction value FCCB. The average value ΔAVE is an average change in the correction value FCCB per unit time.

Step S26 determines whether the average value ΔAVE is equal to or less than a predetermined threshold value α. The threshold value α is for determining whether the correction value FCCB is stabilized. The number M is for preventing erroneously determining the state in which the correction value FCCB fluctuates as shown in FIG. 4 as the state in which the correction value FCCB is stabilized. Steps S22 and S24 calculate the correction values FCCB for the respective cylinders. Therefore, the determination at Step S26 is determination of whether conjunction of the conditions that the average values ΔAVE are equal to or less than the threshold value α in the respective cylinders is established.

While Step S26 is NO, the processing at Steps S18 to S24 is repeated. Alternatively, the processing at Steps S14 to S24 may be repeated. If Step S26 is YES, Step S28 fixes the learning value. The amount provided by dividing the present correction value ISC by N is employed as the correction value of the injection amount common to the cylinders. The correction value ISC/N is for conforming the injection amount to the desired injection amount out of the variation in the injection characteristic. The correction values FCCB are fixed as correction values of the injection periods for correcting the variation in the injection characteristic among the cylinders out of the variation in the injection characteristic. The fixed values ISC/N, FCCB are stored in the constantly-memory-holding memory 32. Thus, the pilot injection can be performed while suitably compensating for the variation in the injection characteristic of the fuel injection valve 16 thereafter.

The correction values ISC/N, FCCB are decided for each fuel pressure in the common rail 12. Therefore, practically, the learning values are learned by performing the processing of Steps S14 to S28 for each fuel pressure. If the learning is once performed based on the processing shown in FIG. 5, Step S12 calculates the command injection amount by dividing a summation of the previously learned correction value ISC and the basic injection amount Qb by N. After the injection period is calculated from the command injection amount, the injection period is corrected with the previously learned correction value FCCB to decide the final command injection period. Thus, once the learning is performed, the deviation amount of the injection characteristic of the fuel injection valve 16 is already compensated before the following learning processing. Accordingly, even if a new deviation is caused, the new deviation is minute. As a result, the convergence time of the correction value FCCB is shortened, and the time necessary for the learning is shortened.

If Step S10 or S20 is NO or if the processing at Step S28 is completed, the series of the processing is ended once.

The present embodiment exerts following effects, for example.

(1) It is determined whether the correction value FCCB is stabilized based on the average value ΔAVE of the change in the correction value FCCB. The correction value FCCB is learned if the stabilization is determined. Thus, the learning of the correction value FCCB can be averted when there is a possibility that the correction value FCCB fluctuates. Moreover, since the correction value FCCB is learned immediately when the correction value FCCB is stabilized. Therefore, the learning period is not lengthened unnecessarily.

(2) The basic injection amount Qb is divided by N and the fuel injection of the amount corresponding to the pilot injection amount is performed N times. Therefore, the learning value of the pilot injection can be learned suitably.

(3) The correction value ISC common to the all cylinders for conforming the average rotational speed of the crankshaft 8 of the diesel engine to the desired rotational speed is learned. Thus, the fuel injection control suitably compensating for the deviation from the standard injection characteristic in addition to the relative variation in the injection characteristic among the cylinders can be performed.

(4) The correction value FCCB is calculated after the correction with the correction value ISC is completed. Thus, the convergence property of the correction value FCCB can be improved compared to the case where the correction value FCCB is calculated before the correction with the correction value ISC is completed.

The above-described embodiment may be modified as follows, for example.

In the above-described embodiment, the correction value FCCB is corrected under a condition that the correction with the correction value ISC is completed. The calculation of the correction value ISC may be started if the change in the correction value FCCB becomes equal to or less than a predetermined value. Also in this case, the learning can be performed with high accuracy by performing the learning when the average value ΔAVE of the change in the correction value FCCB becomes equal to or less than the threshold value α.

The correction value ISC may be a correction value of an injection period instead of the correction value of the fuel injection amount.

The learning method of the deviation amount of the injection characteristic of the fuel injection valve 16 is not limited to the method of obtaining and storing the correction values ISC, FCCB separately. For example, as described in JP-A-2003-254139, the correction values ISC, FCCB may be calculated as the correction values of the injection amount and the learning value may be calculated by adding the correction value ISC divided by N and the correction value FCCB divided by N (ISC/N+FCCB/N).

The fuel injection valve 16 is not limited to the fuel injection valve that uniquely decides the injection amount based on the fuel pressure and the command injection period. The injection amount cannot be decided uniquely by the injection period and the fuel pressure if the fuel injection valve 16 can continuously adjust a lift amount of a nozzle needle in accordance with displacement of an actuator, for example, as described in U.S. Pat. No. 6,520,423. In this case, the operation amount of the fuel injection valve is decided by an energy amount applied to the actuator and a period for applying the energy (i.e., injection period), for example. The injection amount is decided by the fuel pressure, the energy amount and the injection period. In this case, the learning value of at-least one of the energy amount and the injection period should be preferably learned.

The multi-step injection is not limited to the multi-injection containing the pilot injection. Also in the case of multi-injection that performs a minute amount injection other than the pilot injection, the learning of the deviation amount of the fuel injection characteristic as of the minute amount injection based on the injections of the equally divided amounts is effective.

The internal combustion engine is not limited to the diesel engine. For example, a gasoline engine may be used. Even in the case where the engine is used and the engine does not perform the minute amount injection, it is effective to perform the learning under a condition that the fluctuation correction value for correcting the rotation fluctuation among the cylinders is stabilized when the learning for compensating for the variation in the injection characteristic among the cylinders is performed.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel injection controller comprising:
an injecting means for performing fuel injection by operating a fuel injection valve of a multi-cylinder internal combustion engine based on a command value of an injection amount of the fuel injection valve;
a fluctuation restricting means for calculating a fluctuation correction value for restricting rotation fluctuation of an output shaft of the engine among cylinders of the engine and for reflecting the fluctuation correction value in the operation of the fuel injection valve when the fuel injection is performed; and
a learning means for learning a deviation amount of an injection characteristic of the fuel injection valve in accordance with the fluctuation correction value, wherein
the learning means has a determining means for determining whether the fluctuation correction value is stabilized based on an average change in the fluctuation correction value, and
the learning means learns the deviation amount if the determining means determines that the fluctuation correction value is stabilized.

2. The fuel injection controller as in claim 1, wherein
the injecting means performs the injection by dividing the command value into multiple command values of substantially equal injection amounts, and
the deviation amount learned in accordance with the fluctuation correction value is learned as a deviation amount of the injection characteristic of the fuel injection valve about a fuel injection of an amount corresponding to the divided injection amount.

3. The fuel injection controller as in claim 1, further comprising:
a rotation correcting means for calculating a rotation correction value common to all of the cylinders of the engine for conforming an average value of rotational speed of the output shaft of the engine to a desired value and for reflecting the rotation correction value in the operation of the fuel injection valve, and
the learning means learns a deviation amount of the injection characteristic related to the average value in accordance with the rotation correction value.

4. The fuel injection controller as in claim 3, wherein
the fluctuation restricting means calculates the fluctuation correction value if the correction by the rotation correcting means is performed.
